(19) United States
(12) Patent Application Publication
(10) Pub. No.: US 2004/0089390 A1
(43) Pub. Date: May 13, 2004

(54) Reinforcement ply for a tire

(75) Inventors: Pierre Jallais, Chamalieres (FR); Jean-Marc Ruffenach, Cebazat (FR)

Correspondence Address: HAROLD R. BROWN III, BURNS, DOANE, SWECKER & MATHIS, L.L.P., P.O. Box 1404, Alexandria, VA, 22313-1404, US

(73) Assignee: Michelin Recherche Et Technique S.A., Granges-Paccot (CH)

(21) Appl. No.: 10/691,655

(22) Filed: Oct. 24, 2003

Related U.S. Application Data
(63) Continuation of application No. PCT/EP02/04706, filed on Apr. 29, 2002.

(30) Foreign Application Priority Data
May 3, 2001 (FR) 01/05951

(51) Int. Cl. B60C 9/18; B60C 9/20; B60C 9/00; B60C 1/00; B32B 5/12

(52) U.S. Cl. 152/527; 152/526; 152/534; 152/536; 152/537; 428/107

(57) ABSTRACT

Reinforcement ply N for a tire, formed of reinforcement elements embedded in coating products, characterized in that it comprises a first C₁ and a second C₂ layer of metallic elements E₁, E₂ parallel to one another, embedded in a coating product or coating products M₁, M₂ and, between the said two layers C₁ and C₂, a third layer C₃ of elements E₃ made from a textile material and embedded in a coating product M₃, the said textile elements E₃ being orientated relative to the elements E₁ and E₂ at an angle between 70° and 110°.

The invention concerns a tire with radial carcass reinforcement intended for fitting to heavy building site vehicles and/or off-the-road vehicles such as loaders, trucks, graders or scrapers.

The above tire comprises at least, and mainly, a carcass reinforcement of radial metallic cables and, between the said carcass reinforcement and the tread, a crown reinforcement which comprises mainly an armature, referred to as the working armature, composed of at least two plies of inextensible metallic cables, which are parallel to one another in each ply and crossed from one ply to the next, making angles that can be between 0° and 45° relative to the circumferential direction. The use of machinery fitted with such tires also requires that, radially outside the working plies, there should be an additional armature known as the protection armature, consisting of at least one ply of elastic metallic cables. A cable is said to be elastic if, under a tensile force equal to its breaking load, its relative elongation is at least 3%, while a cable said to be inextensible has, under a tensile force equal to 10% of its breaking load, a relative elongation at most equal to 0.2%. The cables of the protection ply or plies make angles that can be between 5° and 35° relative to the circumferential direction, and when there are two plies, these are generally crossed over from one ply to the next.

To obtain a crown reinforcement with good flexibility properties giving greater resistance to the shocks sustained by the tire and greater comfort, patent FR 1 550 749 proposes that the plies of metallic cables forming the said reinforcement must conform to certain rules:

the axial distance a between two cables of diameter d in a given layer must be between 1.75 and 2.4 d,

the radial distance b between two cables in two respective layers must be such that the ratio a/b is between 0.82 and 1.20.

To avoid friction movements at the crossing points of the weft wires or cables in a weft-fabric, patent U.S. Pat. No. 2,151,186 proposes to use as weft elements, rubber or a rubber compound in a plastic and extensible condition, the warp elements, in a manner known as such, being the elements intended to reinforce the fabric while the sole purpose of the weft elements is to maintain the parallelism between the warp elements.

Patent FR 2 614 582, in the case of the very particular structure of a reinforcement for an aircraft tire, proposes to use as the crown reinforcement a laminated or sheet reinforcement product comprising a certain number of reinforcement layers stacked over one another, each of the said layers containing reinforcement elements parallel to one another and embedded in rubber, with the elements of a first layer having central axes offset by a half-step relative to the central axes of the elements of the second layer adjacent to the first. The said arrangement enables a crown reinforcement made from aromatic polyamide reinforcing elements to preserve its shock resistance and to have greater durability.

A tire of the type considered is subjected to harsh treatment by the ground over which it is rolling, particularly in the case of heavy loading and transport vehicles. Such aggression by cutting, sharp and other objects, leads:

a) to cuts in the tread, in the protection plies, but also in the working plies with the possibility of spreading and oxidation of the metallic elements of the said plies by humidity and soil particles,

b) to puncturing of the crown as a whole, while the carcass reinforcement itself may also be punctured depending on the nature and shape of the aggressive object.

To overcome the above disadvantages and improve the resistance of the crown reinforcements of tires of the type considered as much as possible, the present invention proposes a reinforcement ply for a tire, formed of reinforcement elements embedded in rubber mixtures for coating, characterized in that it comprises first and second layers of metallic elements parallel to one another, embedded in a coating mixture or mixtures and, between the two said layers, a third layer of elements made from a textile material embedded in a coating mixture, the said textile elements being orientated relative to the metallic elements at an angle between 70° and 110°.

The textile material can be aliphatic polyamide, polyester, but is preferably aromatic polyamide.

A textile element can be a cable of several strands twisted together, but also a monofilament.

The metallic elements of the first and second layers are preferably steel cables of the so-termed elastic type. The cables of the first layer can be different from those of the second layer, although from the standpoint of production costs it is advantageous to use the same quality of metallic cables for both of the said layers.

The coating product(s) preferably used is/are rubber mixture(s) (although it is possible to use certain plastomers, in particular to embed the textile elements of the third layer of the ply). The metallic and textile reinforcement elements of the three layers of the ply according to the invention can be embedded in a single rubber mixture, but can also be embedded in two rubber mixtures with different compositions an/or properties, with one mixture coating the metallic elements and a second mixture coating the textile elements. The metallic elements of the first and second layers can also be embedded in two different rubber mixtures: a first mixture covering respectively the radially upper and lower faces of the two first layers and a second mixture constituting the respectively lower and upper faces of the said two first layers, the said second mixture preferably being the mixture in which the textile elements of the third layer are embedded.

The characteristics of the present invention will be better understood with the aid of the description of embodiments that are described in a non-limiting way and illustrated by the attached drawing in which:

FIG. 1 represents schematically a ply according to a first variant conforming to the invention, seen in cross-section,

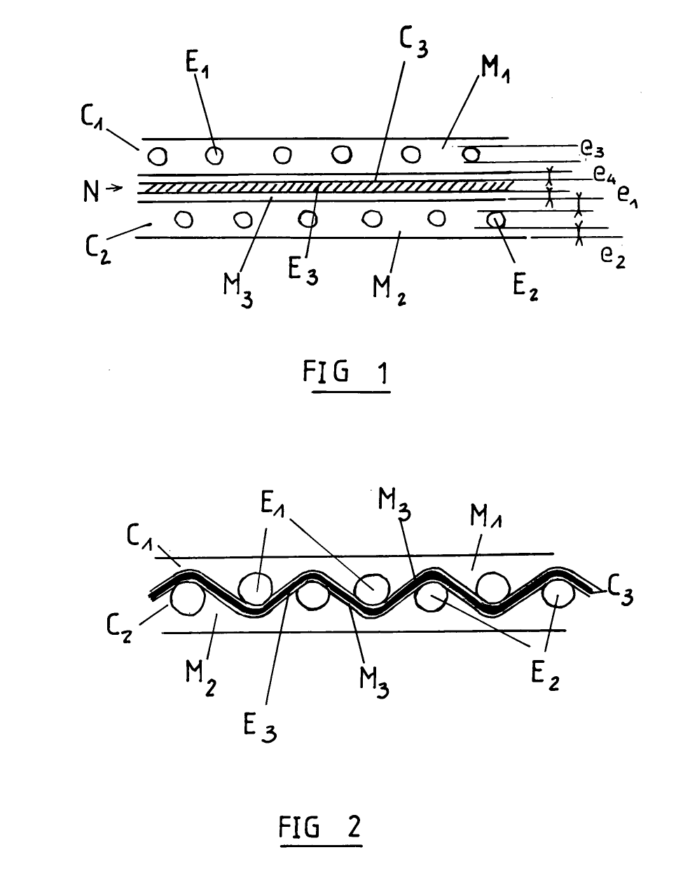

FIG. 2 is a similar representation of a ply according to a second variant,

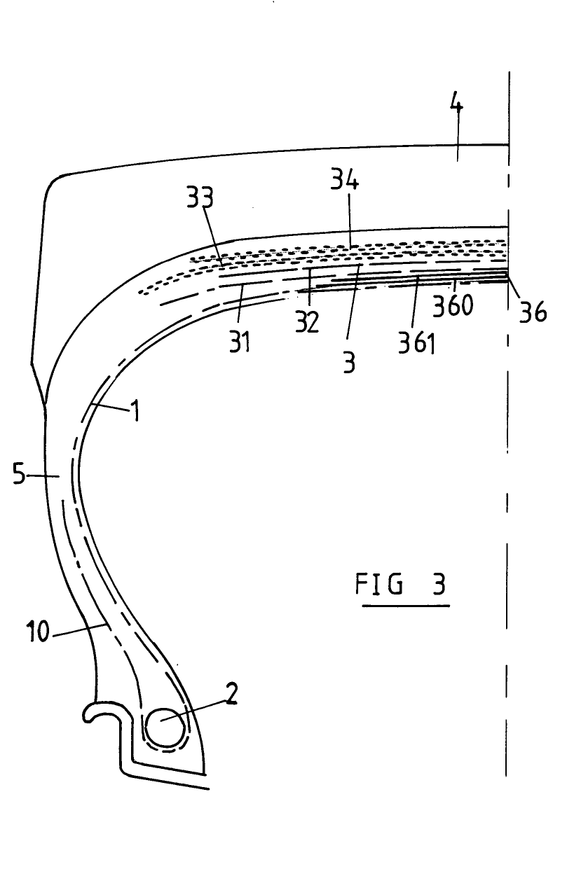

FIG. 3 is a meridian sectioned view of a tire for building sites comprising protection plies according to the invention, and

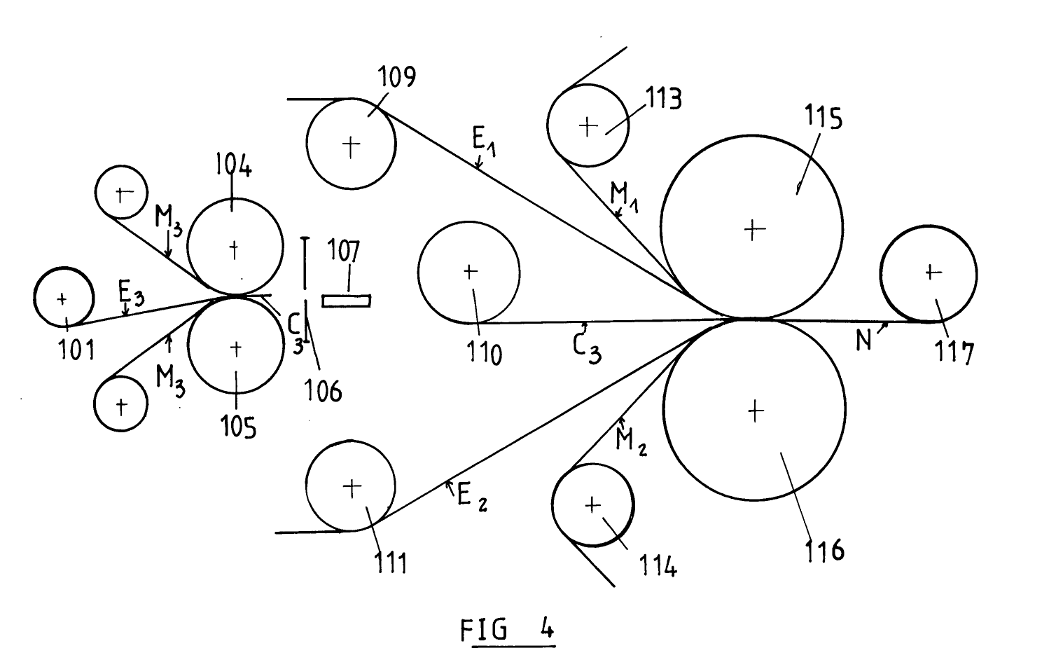

FIG. 4 is a very schematic representation, given by way of example, of the group of machines or tools used for the fabrication of such plies.

FIG. 1 is a sectional view perpendicular to the direction of the main reinforcement elements E₁ and E₂ of the ply N according to the invention. The said elements E₁ and E₂ are metallic cables made of steel, which are elastic: cables are considered elastic which, under a tensile force equal to their breaking load, have a relative elongation of at least 3%. The elements E₁ are embedded in a rubber lining mixture M₁, and with the said mixture constitute the upper layer C₁ of the ply N. The elements E₂ are embedded in a rubber mixture M₂ and, with the said mixture, constitute the lower layer C₂ of the said ply N. The elements E₁ and E₂ are parallel to one another in each layer and are axially separated from one another by a constant interval p. The elements E₁ and E₂ can be different in the two layers C₁ and C₂: for example, cables E₁ of a given structure in the layer C₁ and cables E₂ of a different structure in the layer C₂, but it is best for industrial application if the said elements are identical. The same applies to the mixture M₁ and M₂. Between the two layers C₁ and C₂ is arranged a third layer C₃ of reinforcement elements E₃ embedded in a rubber lining mixture M₃. The said elements E₃ are textile monofilaments of polyamide, whose direction is perpendicular to that of the metallic elements E₁, the elements E₃ being parallel to one another in the layer C₃ and separated from one another by an interval P, which can be between 1.2 and 4 times the interval p. If the thickness of the rubber mixture M₁ over the radially uppermost generatrices of the elements E₁ of the layer C₁ is called e, and the thickness of the same mixture M₁ under the radially lowest generatrices of the same elements is called e₂, e₂ may or may not be equal to e₁. Production costs are reduced if, preferably, the two thicknesses e₁ and e₂ are equal. Similarly, if the thicknesses of the mixture M₃ respectively above the upper generatrices and below the lower generatrices of the elements E₃ of the intermediate layer C₃ are called e₃ and e₄, it is preferable to have e₃=e₄. In contrast, e₃ and e₄ are generally different from e₁ and e₂ granted that the lining mixture M₃ is generally different from the mixture M₁ in its constitution, although perfectly compatible with the mixture M₁ from the standpoint of adhesion between the mixtures, whether in the unvulcanized or in the vulcanized condition.

The ply N shown in FIG. 2 differs from the ply in FIG. 1 mainly in the following respects:

the layers of lining mixture M₁, M₂ respectively under the lower generatrices of the elements E₁ in the upper layer C₁ and over the upper generatrices of the elements E₁ in the lower layer C₂, do not exist, so that the said elements E₁ are in direct contact with the layer of lining mixture M₃,

while the metallic elements E₁ are of the same nature and structure as the elements of FIG. 1, in contrast, the textile elements E₃ in the case described and shown in FIG. 2 are textile cables of aromatic polyamide, which by their constitution are more flexible than monofilaments and, for essentially equal diameters and under the influence of the pressure exerted by the two calendar rolls used to produce the ply, allow interpenetration of the metallic elements E₁ with a consequent reduction of the thickness of the ply N and the appearance of an undulating shape for the intermediate layer C₃.

In FIG. 3, a ply N with three layers C₁, C₂, C₃ constitutes a protection ply 33 or 34 of an off-the-road tire described below. The said tire, of size 18.00-33 XK, comprises a carcass reinforcement consisting of a single ply 1 of radial metallic cables made of steel, which are inextensible, the said ply 1 being anchored in each bead, generally by wrapping around a bead wire 2 to form carcass reinforcement upturns 10, the ends of the said upturns being located essentially half-way up the sidewalls 5. Between the said carcass reinforcement and the tread 4 is arranged a crown reinforcement 3 comprising a first armature, known as the working armature, which consists of at least two plies 31 and 32 of inextensible metallic cables parallel to one another in each ply and crossed from one ply 31 to the next 32, to make angles with the circumferential direction respectively equal to 34° and 20°. The said working reinforcement 3 is completed radially on the inside by a hooping armature 36 of the carcass 1 that takes the form of a block 36 limiting two plies 360 and 361 of inextensible metallic cables orientated relative to the circumferential direction at an angle smaller than the smallest angle of the cables in the working plies and equal to 8°, the axial widths of the said hooping plies 360 and 361 being small compared with the axial widths of the working plies 31 and 32.

Radially outside the working reinforcement 31, 32 is arranged the protection reinforcement which, in the case described, consists of two protection plies 33 and 34, each of these being a ply N consisting of three layers, C₁, C₂, C₃. The layers C₁ and C₂ are identical and consist of elastic metallic cables embedded in a mixture M₁ based on natural rubber. The layer C₃ consists of polyamide monofilaments embedded in the same mixture M₁. The axial widths of the said two protection plies 33 and 34 are such that the axial width of the radially inner protection ply 33 is greater than the axial width of the radially inner working ply 31 and the axial width of the radially outer protection ply 34 is larger than the axial width of the radially outer working ply 32.

The use of such protection plies has led to a very significant increase in the resistance to cuts, while having no adverse affect on the resistance to shocks and punctures: for the same number of hours of rolling over rocky ground, the number of cuts observed in the last protection ply 34 is essentially divided by 1.5, the number of cuts observed in the innermost protection ply 33 is divided by 4, and while the control tire (one with ordinary protection plies) has cuts in the working ply 32, the ply 32 of the test tire has no trace thereof. It must be added that numerous traces of oxidation are observed in the working ply 32 of the control tire, while that of the test tire is intact.

The machinery required for the production of a ply according to the invention is simple and known in itself. Referring to FIG. 4, the third layer C₃ is prefabricated by introducing simultaneously between two rolls 104 and 105 of a calender on the one hand a row of textile elements E₃ wound on a bobbin 101 and on the other hand two layers or sheets of lining mixture M₃. From the rolls 104 and 105 emerges the layer C₃, which is then cut on a cutter 106, in the case described perpendicularly to the calendering direction which is the direction of the elements E₃. The strips obtained are then joined on a joining machine 107 to form a layer C₃ whose elements are perpendicular to the calendering direction on the calender 104, 105, the said layer C₃ being wound onto a bobbin. At the same time as the metallic elements E₁, E₂ (wound on the bobbins 109 and 111) and as the layers of calendering mixture M₁, M₂ emerging from the rollers 113 and 114, the said bobbin 110 feeds a calender formed mainly of the rolls 115 and 116, from which emerges the ply N which is then wound onto the roll 117.

1 - Reinforcement ply for a tire, formed of reinforcement elements embedded in coating products, wherein it comprises a first and a second layer of metallic elements parallel to one another, embedded in a coating product or coating products and, between the said two layers, a third layer of elements made from a textile material and embedded in a coating product, the said textile elements being orientated relative to the metallic elements of the said two layers at an angle between 70° and 110°.

2 - Reinforcement ply according to claim 1 wherein the textile material is aromatic polyamide.

3 - Ply according to claim 1, wherein the textile elements are monofilaments.

4 - Ply according to claim 1, wherein the metallic elements are steel cables said to be elastic and are identical in the first and second layers.

5 - Ply according to claim 4, wherein the rubber mixtures of the three layers have identical constitution.

6 - Ply according to claim 4, wherein the mixtures of the said two layers have identical constitution while the mixture of the third layer has a different constitution.

7 - Tire with a radial carcass reinforcement surmounted radially by a crown reinforcement comprising at least one so-termed protection ply, wherein the said ply is a ply according to any of claims 1 to 6.
